(19) United States
(12) Patent Application Publication
(10) Pub. No.: US 2021/0065638 A1
(43) Pub. Date: Mar. 4, 2021

(54) DISPLAY DEVICE

(71) Applicant: Japan Display Inc., Minato-ku (JP)

(72) Inventor: Mitsutaka OKITA, Tokyo (JP)

(73) Assignee: Japan Display Inc., Minato-ku (JP)

(21) Appl. No.: 16/984,362

(22) Filed: Aug. 4, 2020

(30) Foreign Application Priority Data
Aug. 27, 2019 (JP) 2019-154637

(51) Int. Cl. G09G 3/36

(52) U.S. Cl. CPC G09G 3/3614; G09G 3/3655

(57) ABSTRACT

According to one embodiment, a display device includes scanning lines, a first signal line crossing the scanning lines, a first pixel electrode electrically connected to the first signal line, and a common electrode opposed to the first pixel electrode. In a frame period having a writing period where the scanning lines are sequentially selected and a holding period where the scanning lines are in an unselected state, polarity of a potential of the first signal line is first polarity in the writing period, and is reversed to second polarity different from the first polarity midway through the holding period.

### CROSS-REFERENCE TO RELATED APPLICATIONS

This application is based upon and claims the benefit of priority from Japanese Patent Application No. 2019-154637, filed Aug. 27, 2019, the entire contents of which are incorporated herein by reference.

### FIELD

Embodiments described herein relate generally to a display device.

### BACKGROUND

Recently, in a liquid crystal display device for a smartphone or tablet computer, the improvement in the screen resolution has been progressed, and there has been a tendency toward reduction of the pixel size of the liquid crystal display device. On the other hand, along with an increase in the screen size, an increase in the power consumption of the liquid crystal display device has become a concern. Therefore, reduction of the power consumption by low frequency drive by setting the drive frequency of the liquid crystal display device to less than 60 Hz has been considered.

Such low frequency drive has the following problem. That is, a pixel potential written to a pixel in a writing period gradually decreases during a long holding period, and when a pixel potential is written again in the next writing period, a change in luminance occurs and tends to be visually recognized as a flicker.

### BRIEF DESCRIPTION OF THE DRAWINGS

FIG. 1 is a plan view showing a display device DSP of the present embodiment.

FIG. 2 is an illustration showing a configuration example of the display device DSP of the present embodiment.

FIG. 3 is an illustration showing the equivalent circuit of a pixel PX shown in FIG. 2.

FIG. 4 is a timing chart for explaining an example of control applicable to the display device DSP of the present embodiment.

FIG. 5 is an illustration showing an amount of change in luminance of a comparative example.

FIG. 6 is an illustration showing an amount of change in luminance of the present embodiment.

FIG. 7 is an illustration showing an amount of change in pixel potential in a case where the example of control of the present embodiment is applied.

### DETAILED DESCRIPTION

In general, according to one embodiment, there is provided a display device including scanning lines, a first signal line crossing the scanning lines, a first pixel electrode electrically connected to the first signal line, and a common electrode opposed to the first pixel electrode. In a frame period having a writing period in which the scanning lines are sequentially selected and a holding period in which the scanning lines are in an unselected state, polarity of a potential of the first signal line is first polarity in the writing period, and is reversed to second polarity different from the first polarity midway through the holding period.

The present embodiment will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, and the like of the respective parts are illustrated schematically in the drawings, rather than as an accurate representation of what is implemented, but such schematic illustration is merely exemplary, and in no way restricts the interpretation of the invention. In addition, in the specification and drawings, constituent elements which function in the same or a similar manner to those described in connection with preceding drawings are denoted by the same reference numbers, and detailed explanations of them that are considered redundant may be appropriately omitted.

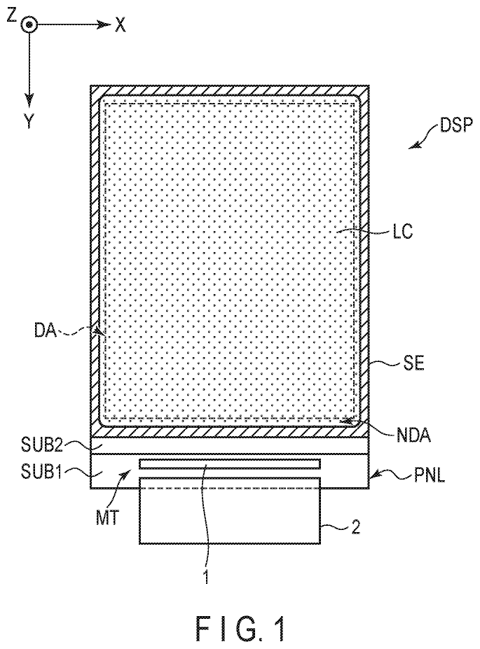

FIG. 1 is a plan view showing the display device DSP of the present embodiment. A first direction X, a second direction Y and a third direction Z are, for example, orthogonal to one another but may cross at an angle other than 90 degrees. The first direction X and the second direction Y correspond to directions parallel to the main surface of a substrate constituting the display device DSP, and the third direction Z corresponds to the thickness direction of the display device DSP.

In the present embodiment, a liquid crystal display device is explained as an example of the display device DSP. The display device DSP includes a display panel PNL. The display panel PNL includes a first substrate SUB1, a second substrate SUB2, a sealant SE and a liquid crystal layer LC. The sealant SE bonds the first substrate SUB1 and the second substrate SUB2 in a state where a cell gap is formed. The liquid crystal layer LC is held between the first substrate SUB1 and the second substrate SUB2.

Although the explanation of the detailed configuration of the display panel PNL is omitted here, the display panel PNL may have a configuration conforming to any one of a display mode using a longitudinal electric field along the third direction Z, a display mode using an inclined electric field inclined with respect to an X-Y plane, a display mode using a lateral electric field along the X-Y plane, and an appropriate combination of the longitudinal electric field, the lateral electric field and the inclined electric field.

The display panel PNL of the present embodiment may be any one of a transmissive type which selectively transmits light from the rear surface side of the first substrate SUB1, a reflective type which selectively reflects light from the front surface side of the second substrate SUB2, and a transflective type.

The display panel PNL includes a display area DA which displays an image, and a frame-shaped non-display area NDA which surrounds the display area DA. The display area DA is located on an inner side surrounded by the sealant SE.

The IC chip 1 and the flexible printed circuit board 2 are located in the non-display area NDA and are electrically connected to the first substrate SUB1. Note that the IC chip 1 may be mounted on the flexible printed circuit board 2. The IC chip 1 includes, for example, a built-in display driver which outputs a signal required for displaying an image, etc.

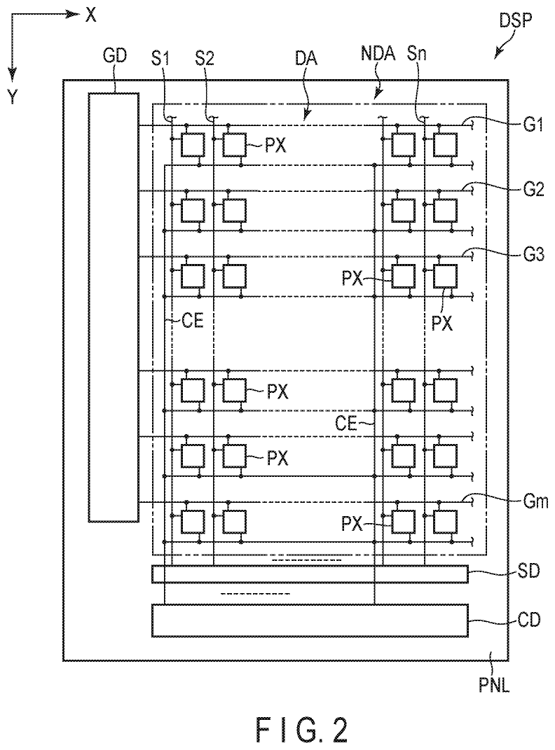

FIG. 2 is an illustration showing a configuration example of the display device DSP of the present embodiment. The display device DSP includes a plurality of pixels PX in the display area DA. The pixels PX are arranged in a matrix in the first direction X and the second direction Y. In addition, the display device DSP includes m scanning lines G (G1 to Gm), n signal lines S (S1 to Sn), a common electrode CE and the like in the display area DA. The n signal lines S cross the m scanning lines G. Note that m and n are integers greater than or equal to 2. Each of scanning lines G is electrically connected to a scanning line drive circuit GD. Each of signal lines S is electrically connected to a signal line drive circuit SD. The common electrode CE is disposed over the pixels PX and is electrically connected to a common electrode drive circuit CD.

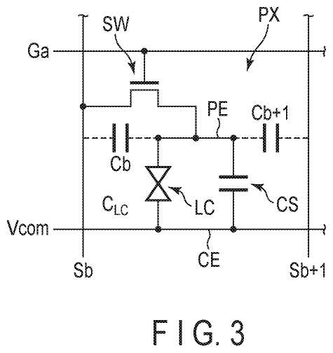

FIG. 3 is an illustration showing the equivalent circuit of a pixel PX shown in FIG. 2. Here, an explanation focuses on a pixel PX electrically connected to a scanning line Ga and a signal line Sb. Note that a signal line Sb and a signal line Sb+1 are adjacent to each other in the first direction X.

The pixel PX includes a switching element SW, a pixel electrode PE, the common electrode CE, a liquid crystal layer LC and the like. The switching element SW is composed of, for example, a thin-film transistor (TFT). The scanning line Ga is electrically connected to not only the switching element SW of the illustrated pixel PX but also the switching element SW of each of the pixels PX arranged in the first direction X shown in FIG. 2. The signal line Sb is electrically connected to not only the switching element SW of the illustrated pixel PX but also the switching element SW of each of the pixels PX arranged in the second direction Y shown in FIG. 2. The pixel electrode PE is electrically connected to the switching element SW. This pixel electrode PE is disposed between the signal line Sb and the signal line Sb+1. The common electrode CE is disposed over the pixels PX, and is opposed to the pixel electrode PE of each of the pixels PX. A common potential Vcom is applied to the common electrode CE. The liquid crystal layer LC is driven by an electric field generated between the pixel electrode PE and the common electrode CE. A storage capacitance CS is formed between, for example, an electrode having the same potential as the common electrode CE and an electrode having the same potential as the pixel electrode PE.

The scanning line G, the signal line S, the switching element SW and the pixel electrode PE are disposed, for example, in the first substrate SUB1. The common electrode CE may be disposed in the first substrate SUB1 or the second substrate SUB2.

A capacitance Cb shown in FIG. 3 indicates a parasitic capacitance between the pixel electrode PE and the signal line Sb, a capacitance Cb+1 indicates a parasitic capacitance between the pixel electrode PE and the signal line Sb+1, and a capacitance CLC indicates the capacitance of the liquid crystal layer LC. In the present embodiment, the capacitance Cb+1 is preferably greater than the capacitance Cb.

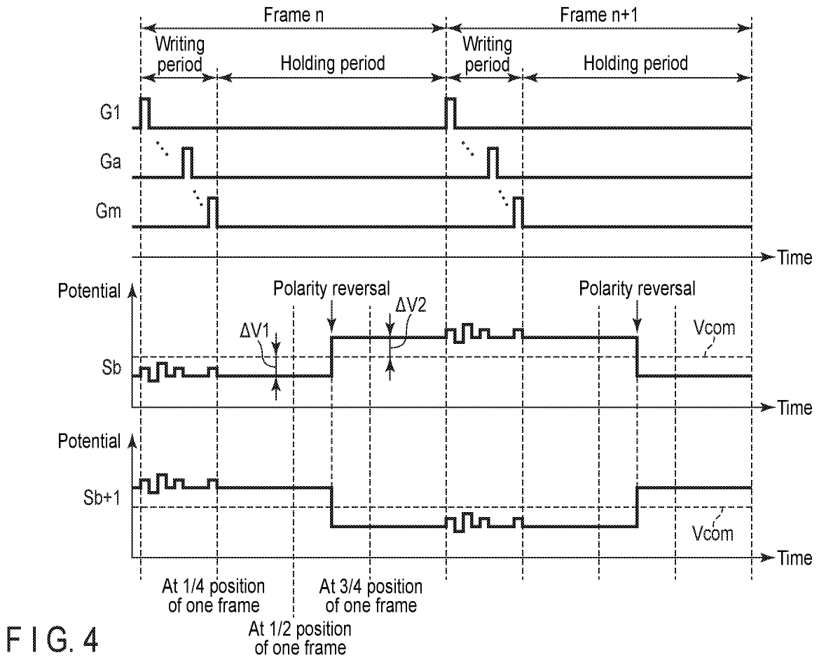

FIG. 4 is a timing chart for explaining an example of control applicable to the display device DSP of the present embodiment.

For example, a frame n and a frame n+1 shown in FIG. 4 are successive in temporal order, the period of time of each frame is referred to as a frame period. The frame period has a writing period in which the scanning lines are sequentially selected, and a holding period in which the scanning lines are in an unselected state. The writing period here corresponds to a period of time in which all of the m scanning lines of the display area DA shown in FIG. 2 are sequentially selected. For example, the writing period corresponds to a period of time from when the scanning line G1 in the first row of the display area DA is selected until when the scanning line Gm in the mth row of the display area DA is set from a selected state to an unselected state. The holding period corresponds to a period of time in which all of the m scanning lines are in an unselected state. For example, the holding period corresponds to a period of time from when the scanning line Gm in the mth row is set to an unselected state in the frame n until when the scanning line G1 in the first row is selected in the frame n+1.

When attention is focused on the potential of the signal line Sb shown in FIG. 3, in the writing period of the frame n, the potential of the signal line Sb is set to potentials to be written to the pixels in the respective rows in accordance with timing with which the m scanning lines are sequentially selected. A potential to be written to each pixel corresponds to a potential in accordance with a tone value of a video signal. For example, in the display device conforming to a normally black mode of displaying black when the voltage applied to the liquid crystal layer is substantially zero, the pixel potential in accordance with the smallest tone value substantially matches the common potential Vcom (the potential difference between the pixel electrode PE and the common electrode CE is substantially zero). In the present embodiment, for example, the smallest tone value (black) is assumed to be zero and the largest tone value (white) is assumed to be 255, and an image having 256 tones can be displayed in the display area DA.

Then, the potential of the signal line Sb is maintained to be a fixed potential in the holding period of the frame n. However, with regard to the potential of the signal line Sb, the polarity is reversed midway through the holding period. In the example shown in FIG. 4, the potential of the signal line Sb is less than the common potential and has negative polarity (first polarity) in the writing period of the frame n. The potential of the signal line Sb is set to the first fixed potential having negative polarity (first polarity) in the first half of the holding period of the frame n, and is set to the second fixed potential greater than the common potential and having positive polarity (second polarity) in the second half of the holding period. A potential difference ΔV1 between the common potential Vcom and the first fixed potential substantially matches a potential difference ΔV2 between the common potential Vcom and the second fixed potential.

In a case where the smallest tone value (black) is zero and the largest tone value (white) is 255, the first fixed potential and the second fixed potential are, for example, potentials corresponding to a tone value of greater than or equal to 31, and are preferably potentials corresponding to a tone value of 255.

The first half of the holding period corresponds to a period of time from the end of the writing period until the polarity reversal, and is referred to as the first holding period. The second half of the holding period corresponds to a period of time from the polarity reversal until the start of the writing period of the frame n+1, and is referred to as the second holding period.

With regard to the timing of polarity reversal midway through the holding period, the polarity is reversed, for example, in a period of time of greater than or equal to ¼ but less than or equal to ¾ of one frame period, and preferably in the substantially middle (½) of one frame period. For example, the length of the first holding period is less than or equal to the length of the second holding period. The length of the first holding period is preferably less than the length of the second holding period.

In the frame n+1, the potential of the signal line Sb has positive polarity in the writing period, is set to the second fixed potential having positive polarity in the first half of the holding period, and is set to the first fixed potential having negative polarity in the second half of the holding period.

When attention is focused on the potential of the signal line Sb+1 shown in FIG. 3, in the frame n, the potential of the signal line Sb+1 has positive polarity in the writing period, is set to the second fixed potential having positive polarity in the first half of the holding period (first holding period), and is set to the first fixed potential having negative polarity in the second half of the holding period (second holding period).

In the frame n+1, the potential of the signal line Sb+1 has negative polarity in the writing period, is set to the first fixed potential having negative polarity in the first half of the holding period, and is set to the second fixed potential having positive polarity in the second half of the holding period.

The timing of the polarity reversal of the potential of the signal line Sb+1 substantially matches the timing of the polarity reversal of the potential of the signal line Sb.

Next, the effect of the polarity reversal of the fixed potential supplied to the signal line midway through the holding period will be explained. Here, it is assumed that a potential corresponding to the same tone value is written to all the pixels PX of the display area DA, and for example, a case where an image of halftone having a tone value of 127 is displayed on the entire screen is explained. In addition, here, it is assumed that low-frequency drive in which a drive frequency is less than 60 Hz is employed from the perspective of reduction of power consumption.

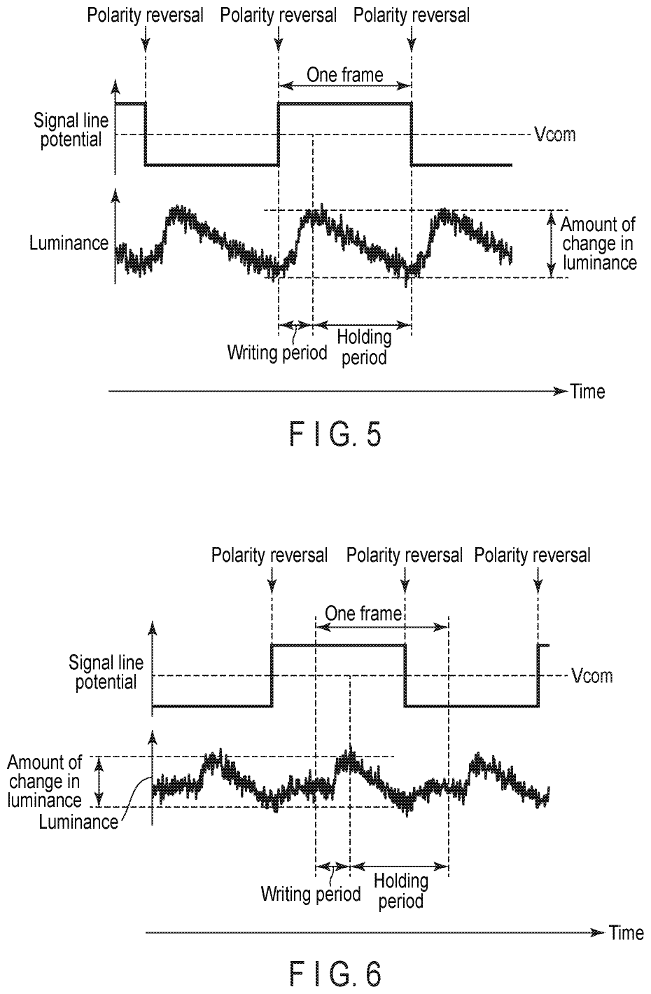

FIG. 5 is an illustration showing an amount of change in luminance of a comparative example.

In the comparative example, the polarity of the potential of the signal line is reversed at the end of the holding period of the previous frame period or the start of the writing period of the current frame period. In the writing period, the potential of each signal line is written to each pixel of the selected scanning line. The potential of the signal line written to the pixel is held as a pixel potential over the holding period. During the holding period, the written pixel potential gradually decreases (decreases toward the common potential Vcom) due to electric discharge. In the case of low-frequency drive, since the holding period is long, the decrease in pixel potential is particularly significant. In the next frame period, when the potential equal to that of the previous frame period is written to the pixel, the amount of change in pixel potential is large, and the amount of change in luminance displayed is large accordingly. Such a change in luminance tends to be visually recognized as a flicker.

FIG. 6 is an illustration showing an amount of change in luminance of the present embodiment.

In the present embodiment, as explained with reference to FIG. 4, the polarity of the potential of the signal line is reversed midway through the holding period. In the holding period, similarly to the comparative example, the written pixel potential gradually decreases due to electric discharge. However, in the present embodiment, the polarity of the fixed potential supplied to the signal line changes midway through the holding period. The signal line and the pixel electrode are coupled with each other via the capacitance Cb shown in FIG. 3, and when the potential of the signal line shifts, the pixel potential of the capacitively coupled pixel electrode shifts accordingly. By the polarity reversal of the potential of the signal line, the pixel potential shifts upward. Therefore, as compared with the comparative example of FIG. 5, the amount of change in the pixel potential in the holding period is reduced, and the amount of change in the luminance displayed is reduced accordingly. Therefore, degradation in display quality can be suppressed.

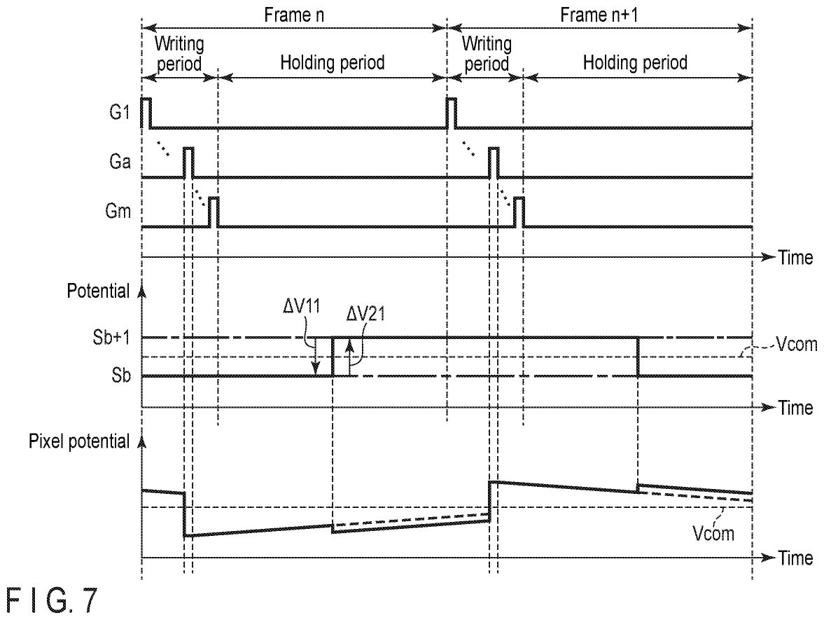

FIG. 7 is an illustration showing an amount of change in pixel potential in a case where an example of control of the present embodiment is applied.

Here, attention is focused on the pixel PX explained with reference to FIG. 3. This pixel PX includes the pixel electrode PE disposed between the signal line Sb and the signal line Sb+1 as described above. The pixel electrode PE is electrically connected to the scanning line Ga and the signal line Sb.

As shown by a solid line, the potential of the signal line Sb has negative polarity in the writing period and the first half of the holding period of the frame n, and has positive polarity in the second half of the holding period of the frame n and the writing period of the frame n+1. On the other hand, as shown by a dot-dash line, the potential of the signal line Sb+1 has positive polarity in the writing period and the first half of the holding period of the frame n, and has negative polarity in the second half of the holding period of the frame n and the writing period of the frame n+1.

In the writing period, with timing with which the scanning line Ga is selected, the potential of the signal line Sb is written to the pixel PX. That is, in the frame n, since the potential corresponding to the video signal having negative polarity is written to the pixel PX via the signal line Sb, the pixel potential has negative polarity. After that, in the holding period of the frame n, the pixel potential gradually shifts toward the common potential Vcom. In the holding period of the frame n, the polarity of the fixed potential of the signal line Sb is reversed from negative polarity to positive polarity, and the polarity of the fixed potential of the signal line Sb+1 is reversed from positive polarity to negative polarity.

The pixel potential of the pixel PX shifts along with the fluctuations of the potentials of the capacitively coupled signal lines Sb and Sb+1. That is, the pixel electrode PE of the pixel PX is coupled with the signal line Sb via the capacitance Cb, and is coupled with the signal line Sb+1 via the capacitance Cb+1. The influence of the fluctuations of the potentials of the signal lines Sb and Sb+1 on the pixel potential will be described below.

The fluctuation of the pixel potential along with the fluctuation of the potential of the signal line Sb+1 is proportional to (Cb+1)/Ctotal×(ΔV11). Since the potential of the signal line Sb+1 changes from the fixed potential having positive polarity to the fixed potential having negative polarity, ΔV11 is a negative value. Therefore, the pixel potential decreases (in other words, the pixel potential shifts in the negative direction).

On the other hand, the fluctuation of the pixel potential along with the fluctuation of the potential of the signal line Sb is proportional to (Cb)/Ctotal×(ΔV21). Since the potential of the signal line Sb changes from the fixed potential having negative polarity to the fixed potential having positive polarity, ΔV21 is a positive value. Therefore, the pixel potential increases (in other words, the pixel potential shifts in the positive direction).

Now, in the frame n, since the potential having negative polarity is written to the pixel PX, if (Cb+1)/Ctotal×(ΔV11) is greater than (Cb)/Ctotal×(ΔV21), the pixel potential decreases. That is, the pixel potential shifts away from the common potential Vcom. It means that the absolute value of the potential difference between the pixel potential and the common potential increases, and the luminance of the pixel PX changes upward.

In short, in a case where column-reversal drive in which the potentials of the signal lines adjacent to each other have reverse polarity with respect to each other is employed, it is important to set the capacitance (Cb+1) with the adjacent signal line to greater than the capacitance (Cb) with the signal line electrically connected to the pixel from the perspective of suppression of the decrease in luminance in the holding period of the pixel PX.

As described above, by the setting to (Cb+1)>(Cb) and the polarity reversal of the potential of the signal line in the holding period, the absolute value of the pixel potential is increased, and the luminance of the pixel PX can be increased.

Note that the first fixed potential having negative polarity and the second fixed potential having positive polarity in the holding period are not necessarily equal to the display tone of the previously written pixel PX. For example, by setting the first fixed potential and the second fixed potential to the potential corresponding to the tone value of 255, the change in potential at the time of polarity reversal can be increased, and the pixel potential can be shifted in a direction in which the luminance of the pixel PX is increased.

As explained above, according to the present embodiment, a display device which can suppress degradation in display quality can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
scanning lines;
a first signal line crossing the scanning lines;
a first pixel electrode electrically connected to the first signal line; and
a common electrode opposed to the first pixel electrode, wherein
in a frame period having a writing period in which the scanning lines are sequentially selected and a holding period in which the scanning lines are in an unselected state, polarity of a potential of the first signal line is first polarity in the writing period and is reversed to second polarity different from the first polarity midway through the holding period.

2. The display device of claim 1, wherein
the potential of the first signal line is a first fixed potential having the first polarity in a first holding period from when the writing period ends until when the polarity is reversed, and
the potential of the first signal line is a second fixed potential having the second polarity in a second holding period from when the potential is reversed until when a writing period of a next frame period starts.

3. The display device of claim 2, wherein a potential difference between a common potential of the common electrode and the first fixed potential substantially matches a potential difference between the common potential and the second fixed potential.

4. The display device of claim 3, wherein the first fixed potential and the second fixed potential are potentials corresponding to a tone value of greater than or equal to 31 when a smallest tone value is zero and a largest tone value is 255.

5. The display device of claim 4, wherein the first fixed potential and the second fixed potential are potentials corresponding to a tone value of 255.

6. The display device of claim 1, wherein the polarity is reversed in a period of time of greater than or equal to ¼ but less than or equal to ¾ of the frame period.

7. The display device of claim 6, wherein the polarity is reversed in a substantially middle of the frame period.

8. The display device of claim 2, further comprising a second signal line adjacent to the first signal line, wherein
polarity of a potential of the second signal line is the second polarity in the writing period, and is reversed to the first polarity midway through the holding period.

9. The display device of claim 8, wherein the potential of the second signal line is the second fixed potential in the first holding period, and is the first fixed potential in the second holding period.

10. The display device of claim 8, wherein timing with which the polarity of the potential of the first signal line is reversed substantially matches timing with which the polarity of the potential of the second signal line is reversed.
